(19) United States
(12) Patent Application Publication
(10) Pub. No.: US 2010/0009044 A1
(43) Pub. Date: Jan. 14, 2010

(54) A READY-FOR-USE BAKERY DOUGH PRODUCT

(75) Inventors: Jonas Halden, Winterthur (CH); Sona Plencnerova, Singen (DE); Ulrich Erle, Feuerthalen (CH); Oscar Reiniero Perez, Singen (DE); Robert White, Singen (DE)

Correspondence Address: K&L Gates LLP, P.O. Box 1135, CHICAGO, IL, 60690, US

(73) Assignee: NESTEC S.A., Vevey (CH)

(21) Appl. No.: 12/530,056

(22) PCT Filed: Mar. 6, 2007
(86) PCT No.: PCT/EP2007/052094

§ 371 Date: Sep. 4, 2009

(51) Int. Cl. B65D 81/34; A21D 2/02; A21D 10/02; A21D 2/18

(52) U.S. Cl. 426/128; 426/551; 426/552

(57) ABSTRACT

The invention concerns a ready-for-use bakery dough product, which can be cooked in a microwave and which is prepared from a mixture comprising—from 11 to 25% flour,—from 0.5 to 2.0% of baking powder—from 10 to 40% of sugar,—from 0.1 to 0.8% of a polymer of methylcellulose and hydroxypropyl Methylcellulose,—the remaining being oil, egg, flavour, starch, salt, emulsifier and water.

The present invention concerns a ready-for-use bakery dough product, which can be cooked in a microwave.

Product dough, which can be cooked in a microwave are already known and available for the consumer. These types of products are normally dry mixtures, which have to be reconstituted in water and then put for cooking in a microwave. The problem with these products is that the quality of the cooked dough is absolutely not satisfactory for the consumer, due to a bad texture and a bad surface crispiness.

The objective of the present invention is to provide to the consumer a ready-for-use bakery dough, which has not the above mentioned drawbacks. Furthermore, it is another objective of the invention to have such a bakery dough, wherein the cooking is carried out very quickly. A further objective is also to provide to the consumer a single serve packaging so that said consumer can decide freely how many articles he wants to have ready to cook and ready to eat.

The present invention concerns a ready-for-use bakery dough product, which can be cooked in a microwave and which is prepared from a mixture comprising
from 11 to 25% flour,
from 0.5 to 2.0% of baking powder
from 10 to 40% of sugar,
from 0.1 to 0.8% of a polymer of methylcellulose and hydroxypropyl Methylcellulose,
the remaining being oil, egg, flavour, starch, salt, emulsifier and water.

The polymer used is preferably Gum Methocel. Methocel is a Trade-Mark of Dow Chemical.

It is important according to the invention to have certain compounds present in specific ranges to reach first the wanted quality after the cooking and secondly the required speed cooking.

The first objective of the invention is to have a muffin dough. The second objective is to have this muffin dough with chocolate pieces and the third objective is to have a dough in a tray, wherein a solid chocolate core is placed in said tray. In the spirit of this third objective, the basic composition of ready-for-use dough is the same as the composition for the first and the second objective.

According to the first objective, it is important to have a more specific amount of flour comprised between 12 and 17% and the amount of starch comprised between 1 and 3%. All the percentages mentioned in the present specification are given in weight. The reason of this specific range is to reach a good elasticity and toughness of the cooked dough.

There is no criticality in the used starch. Preferably the starch is corn starch, wheat starch or potato starch.

Concerning the flour used, said flour is taken in the group consisting of wheat flour, corn flour, and all other types of flour containing gluten. The wheat flour is preferred, because the gluten present in this flour allows a better texture formation due to gluten.

Another important feature of the invention is to have a certain amount of baking powder in the recipe of the dough. A most preferred amount of baking powder is in the range 0.8 to 1.2%. Under baking powder in the present specification, we understand a mixture of at least one bicarbonate or carbonate salt, at least one acidifying agent and at least one separating agent. Sodium bicarbonate is preferably used with sodium diphosphate or disodium dihydrogen pyrophosphate with a starch as separating agent. These mixtures are directly available commercially with a fixed composition. The baking powder in the above mentioned specific range is of importance to induce a rapid steam formation.

The sugar amount according to the present invention is preferably comprised between 16 and 27%. The reason of this specific range is to allow a longer storage of the product, like 60 days shelf-life.

Another important feature of the invention is the presence of Gum Methocel. Methocel is a Trade-Mark of Dow Chemical. This compound is a water cellulose ethers. More specifically, it is a polymer of methylcellulose and hydroxypropyl Methylcellulose. A preferred range of this compound is 0.2 to 0.5%. The presence of this compound allows a better microwave heating of the interior and avoids also a dryness of the cooked dough.

Also of importance according to the invention is the amount of oil in the recipe. In a preferred embodiment, the amount of oil is comprised between 18 and 21%. The presence of oil in this range allows an even heating of the dough in the microwave.

There is no criticality in the type of oil or fat used. Preferably, the oil or fat is taken from the group consisting of canola oil, sunflower oil, butter.

The amount of egg is also of importance. The amount of egg is preferably comprised between 1.5 and 2.5%. This amount is based on the egg dry matter. It is important to have this range to avoid a dryness of the product after cooking.

It is also known for the man skilled in the art, that the bakery dough contains flavours. These flavours are taken from the group consisting of chocolate, vanilla, butter flavors. The amount of these flavours is not critical.

The bakery dough according to the invention has also a water content, which is higher than 20%. This is of importance to have sufficient water available for the hydration of the different ingredients. In a preferred embodiment, the amount of water is comprised between 20 and 25%.

The amount of protein in the flour is comprised between 7 and 14%. As known, the biggest part of the protein in the flour is gluten. This is of importance for the formation of the structure.

Glycerol can also be present in the bakery dough composition, for reason of shelf stability.

The emulsifier is normally present in the bakery dough product in an amount comprised between 0.5 and 1.5%. The emulsifier is any emulsifier known by the man skilled in the art. For example, the emulsifier can be a monoglyceride.

The bakery dough according to the invention can be preserved in the refrigerator, that means has an Aw below 0.89 and a shelf-life in the fridge of around 60 days. It is also possible to have according to the invention a frozen bakery dough.

According to the second objective of the present invention, it is also possible to add in the above described mixture chocolate pieces. The amount of the chocolate pieces is comprised between 1 and 8%. In this case also, it is possible either to have a chilled or a frozen product.

The above mentioned ready-for-use bakery dough is packaged to deliver to the consumer. The present invention concerns further an assembly comprising
the ready-for-use bakery dough described above for muffin and
a tray containing said ready-for-use bakery dough.

Said tray is a classical muffin cup, like paper coated with Polyethylene.

The present assembly for muffin dough presents also a tray closed with a lid.

The way of manufacturing the present bakery dough is according to known techniques from the man skilled in the art. It is important according to the invention to prepare the dough by mixing the different components, to fill said dough in the tray, to flush with nitrogen and finally to close the tray with the lid.

According to the third objective of the invention, the bakery dough contains a solid chocolate core. According to this solution, the present invention concerns an assembly comprising
the ready-for-use bakery dough as described above including further a solid chocolate core,
a susceptor tray containing said ready-for-use bakery dough and
a susceptor lid closing said tray.

In the assembly of the invention, the chocolate core represents 10 to 30% of the whole bakery dough.

In this case, the susceptor tray comprises a patterned susceptor structure. The lid of the assembly comprises also a patterned susceptor structure.

The susceptor is an active microwave energy heating element in the form of a laminate including a substrate formed of suitable material such as for example paper, paperboard or a polymeric film, a microwave energy interactive material on one surface of the substrate and a susceptor on said microwave energy interactive material.

The design of the active microwave energy heating element moderates penetration of microwave energy in the peripheral region of the food product and directs microwave energy towards its central region.

The following examples give a detailed description of the bakery dough according to the invention.

### EXAMPLE 1

### Muffin

A batter is prepared by making first a dry mix with 30% of sugar, 20% of flour, 5% of chocolate morcels, 1% of emulsifier, 2% of wheat gluten, 2.5% of egg, 1% of baking powder and 0.5% of gum methocel. Then, a liquid mix is prepared by mixing 20% of water, 17% of oil, the remaining being flavours. The dry mix and the liquid mix are joined and 70 g of the obtained dough is disposed in a tray.

The tray is placed in a 750 W microwave: the muffin is ready cooked after one minute. The muffin has a fluffy and aerated structure without toughness.

### EXAMPLE 2

### Chocolate Cake

The same raw dough as prepared in the preceding example is used and 100 g of dough is disposed in a susceptor tray with pattern. A core of 25 g of chocolate is placed in said dough. The tray is placed in a 750 W microwave. After 2 minutes the cake is ready to be eaten by the consumer. The cake has a fluffy aerated structure with a liquid core and a crispy surface.

1. A ready-for-use bakery dough product, which can be cooked in a microwave and is prepared from a mixture comprising
from 11 to 25% by weight flour;
from 0.5 to 2.0% by weight baking powder;
from 10 to 40% by weight sugar;
from 0.1 to 0.8% by weight of a polymer of methylcellulose and hydroxypropyl methylcellulose; and,
oil, egg, flavour, starch, salt, emulsifier and water.

2. A ready-for-use bakery dough product according to claim 1, wherein the mixture comprises chocolate pieces.

3. A ready-for-use bakery dough product according to claim 1, wherein the amount of chocolate pieces is between 1 and 8% by weight.

4. A ready-for-use bakery dough product, wherein the flour content is between 12 and 17% by weight and the amount of starch between 1 and 3% by weight.

5. A ready-for-use bakery dough according to claim 1, wherein the starch is selected from the group consisting of corn starch, wheat starch and potato starch.

6. A ready-for-use bakery dough according to claim 1, wherein the flour is selected from the group consisting of wheat flour, and corn flour.

7. A ready-for-use bakery dough according to claim 1, wherein the amount of baking powder is between 0.8 to 1.2% by weight.

8. A ready-for-use bakery dough according to claim 1, wherein the amount of sugar is between 16 to 27% by weight.

9. A ready-for-use bakery dough according to claim 1, wherein the amount of the polymer of methylcellulose and hydroxypropyl methylcellulose is between 0.2 and 0.5% by weight.

10. A ready-for-use bakery dough according to claim 1, wherein the amount of oil is between 18 and 21% by weight.

11. A ready-for-use bakery dough according to claim 1, wherein the oil or fat is selected from the group consisting of Canola oil, sunflower oil, butter.

12. A ready-for-use bakery dough according to claim 1, wherein the amount of egg is between 1.5 and 2.5% by weight.

13. A ready-for-use bakery dough according to claim 1, wherein the flavour is selected from the group consisting of chocolate, vanilla, and butter flavors.

14. A ready-for-use bakery dough according to claim 1, wherein the amount of water is greater than 20% by weight.

15. A ready-for-use bakery dough according to claim 1, wherein the amount of water is between 20 and 25% by weight.

16. A ready-for-use bakery dough according to claim 1, wherein the amount of protein in the flour is between 7 and 14% by weight.

17. A ready-for-use bakery dough according to claim 1, wherein the mixture comprises glycerol.

18. A ready-for-use bakery dough according to claim 1, wherein the emulsifier is a monoglyceride, present in an amount between 0.5 to 1.5% by weight.

19. A ready-for-use bakery dough according to claim 1, which can be preserved in the refrigerator in frozen form.

20. An assembly comprising
a ready-for-use bakery dough, which can be cooked in a microwave and is prepared from a mixture comprising from 11 to 25% by weight flour; from 0.5 to 2.0% by weight baking powder; from 10 to 40% by weight sugar; from 0.1 to 0.8% by weight of a polymer of methylcellulose and hydroxypropyl methylcellulose; and oil, egg, flavour, starch, salt, emulsifier and water; and
a tray containing the ready-for-use bakery dough.

21. An assembly according to claim 20, wherein the tray is closed with a lid.

22. An assembly comprising
a ready-for-use bakery dough which can be cooked in a microwave and is prepared from a mixture comprising from 11 to 25% by weight flour; from 0.5 to 2.0% by weight baking powder; from 10 to 40% by weight sugar; from 0.1 to 0.8% by weight of a polymer of methylcellulose and hydroxypropyl methylcellulose; and oil, egg, flavour, starch, salt, emulsifier and water comprising a solid chocolate core;
a susceptor tray containing the ready-for-use bakery dough; and
a susceptor lid closing the tray.

23. An assembly according to claim 22, wherein the chocolate core comprises 10 to 30% by weight of the whole bakery dough.

24. An assembly according to claim 22, wherein the susceptor tray comprises a patterned susceptor structure.

25. An assembly according to claim 22 wherein the lid comprises a patterned susceptor structure.

26. A ready-for-use bakery dough product according to claim 1 wherein the flour comprises gluten.

27. A dough product comprising:
from 11 to 25% by weight flour;
from 0.5 to 2.0% by weight of baking powder;
from 10 to 40% by weight of sugar;
from 0.1 to 0.8% by weight of a polymer of methylcellulose and hydroxypropyl methylcellulose; and
oil, egg, flavour, starch, salt, emulsifier and water.
